(19) United States
(12) Patent Application Publication
(10) Pub. No.: US 2025/0391173 A1
(43) Pub. Date: Dec. 25, 2025

(54) AUTONOMOUS VEHICLE LEAK DETECTION

(71) Applicant: Torc Robotics, Inc., Blacksburg, VA (US)

(72) Inventor: Fridtjof Stein, Ostfildern (DE)

(21) Appl. No.: 19/085,483

(22) Filed: Mar. 20, 2025

(30) Foreign Application Priority Data
Jun. 25, 2024 (DE) DE102024117864.7

(51) Int. Cl. G06V 20/52; B60R 11/04; G06T 7/00; G06V 10/62; G06V 10/75

(52) U.S. Cl. CPC G06V 20/52; B60R 11/04; G06T 7/0002; G06V 10/62; G06V 10/751; G06T 2207/30252

(57) ABSTRACT

A commercial vehicle with at least one camera configured to detect leaks is disclosed. The at least one camera is arranged and aligned to capture a region of interest beneath the commercial vehicle, wherein a processing unit is connected to the camera and is configured to read an image from the at least one camera at regular intervals when the commercial vehicle is stationary and to detect differences between the images and to classify them as hypotheses, including leak spot hypotheses, animal hypotheses, shadow hypotheses and precipitation hypotheses. and when a leak spot hypothesis is verified, to determine its location in relation to predetermined regions beneath the commercial vehicle in order to establish a defect hypothesis related to the cause of the leak.

### CROSS-REFERENCE TO RELATED APPLICATIONS

The present application claims priority to German Patent Application No. 102024117864.7 filed on Jun. 25, 2024, and titled “COMMERCIAL VEHICLE”, which is hereby incorporated by reference in its entirety.

### TECHNICAL FIELD

The present disclosure relates to a vehicle with a camera. In particular, the present disclosure relates to utilizing the camera to detect leaks originating from the vehicle.

### BACKGROUND

Detecting leaks on a vehicle can help avoid high repair costs.

U.S. Pat. No. 10,586,448 B2 describes a method for reducing risks when accessing passenger vehicles. The method comprises detecting a dangerous condition in a region near a vehicle using one or more sensors. A processor can calculate a safety metric according to the hazard state and analyze the safety metric relative to a given threshold. A vehicle occupant can be automatically notified of the dangerous condition when the safety metric meets the specified threshold.

The object of the present disclosure is to specify a novel commercial vehicle.

### BRIEF DESCRIPTION

A commercial vehicle with at least one camera configured to detect leaks is proposed. According to the present disclosure, the at least one camera is arranged and aligned to capture a region of interest beneath the commercial vehicle, wherein a processing unit is connected to the camera and configured to read an image from the at least one camera at regular intervals when the commercial vehicle is stationary and to detect differences between the images and to classify them as hypotheses, including leak spot hypotheses, animal hypotheses, shadow hypotheses and precipitation hypotheses, and when a leak spot hypothesis is verified, to determine its location in relation to predetermined regions beneath the commercial vehicle in order to create a defect hypothesis related to the cause of the leak.

The system of the present disclosure allows a constant monitoring of a vehicle for leaks of liquids or trickle loads with a short latency between the occurrence of the defect and detection. False positive detections can at least be largely excluded.

The system of the present disclosure can be used in an autonomous vehicle, in particular an autonomous commercial vehicle, bus or passenger car, but also in an assistance system of a vehicle configured for operation with a human driver.

### BRIEF DESCRIPTION

Exemplary embodiments of the present disclosure will be explained in more detail hereinafter with reference to the drawings.

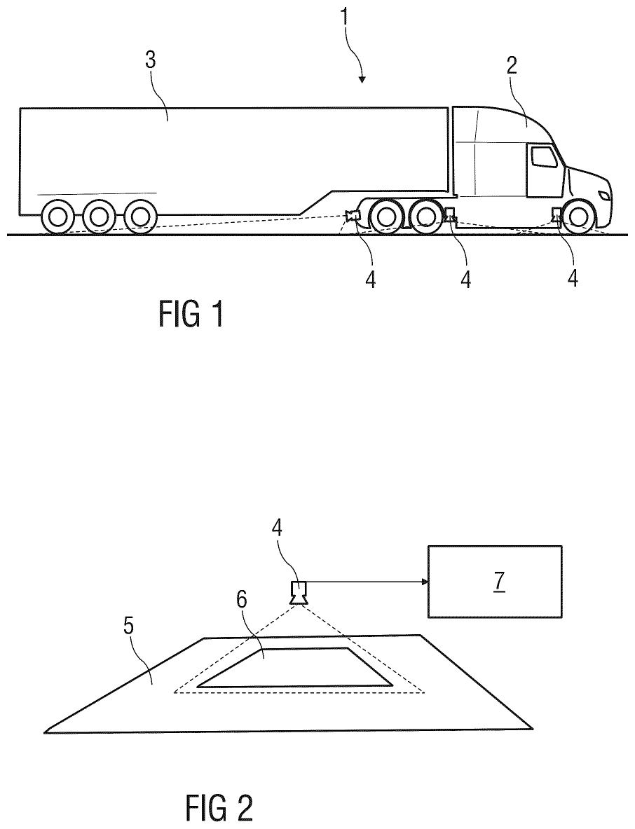

FIG. 1 shows a schematic view of a vehicle.

FIG. 2 shows a schematic view of a roadway with a region of interest captured by a camera.

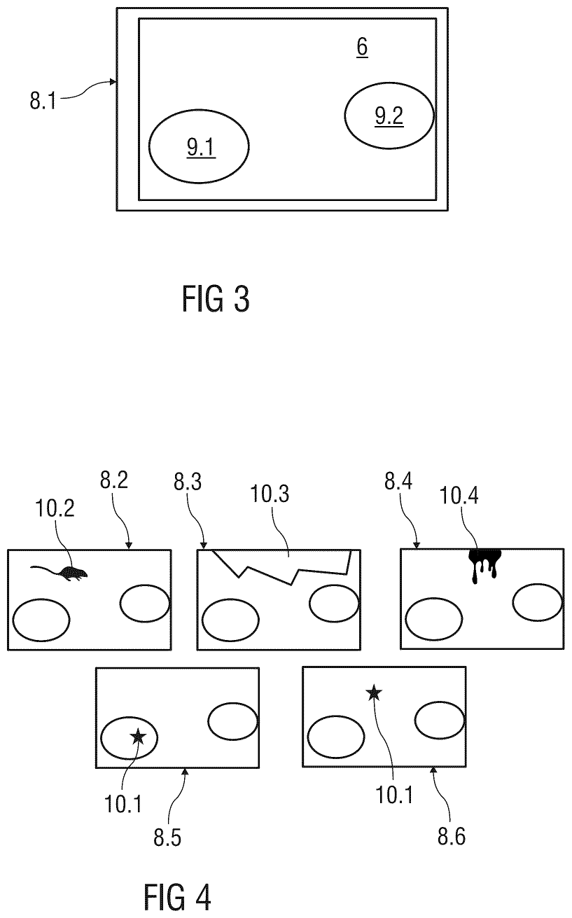

FIG. 3 shows a schematic view of an image taken by the camera.

FIG. 4 shows a schematic view of a sequence of images.

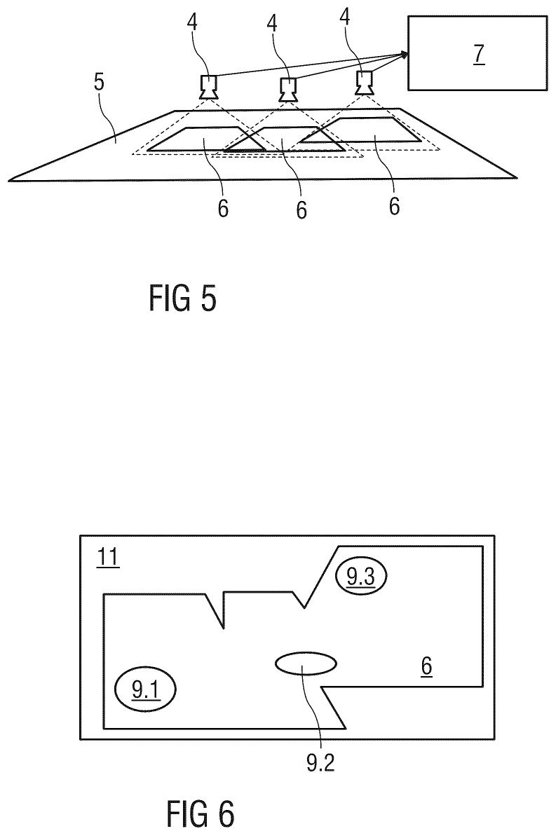

FIG. 5 shows a schematic view of the roadway with a region of interest captured by several cameras.

FIG. 6 shows a schematic view of a concatenated image formed from images of the cameras by concatenation.

Corresponding parts are provided with the same reference numerals in all figures.

### DETAILED DESCRIPTION

FIG. 1 is a schematic view of a vehicle 1, for example a commercial vehicle 1, which may, for example, have a tractor 2 and a semitrailer 3 or trailer 3. The vehicle 1, in particular the tractor 2, but optionally also the semitrailer 3 or trailer 3, is equipped with at least one camera 4, and for example, multiple cameras 4, which is/are arranged and aligned to capture a region of interest 6 beneath the vehicle 1, for example on a road surface.

The vehicle 1 can be designed as an autonomous vehicle 1 or semi-autonomous vehicle 1, for example. The at least one camera 4 is used to detect leaks. Shadows can be detected by means of lighting. Based on the location of the leak, a hypothesis can be made about the leaked substance.

By means of the cameras 4, constant monitoring of the region beneath the vehicle 1 is possible.

The cameras 4 can, for example, be surveillance cameras configured for a pre-drive check beneath the semitrailer 3 or trailer 3 and beneath the tractor 2 to check whether there is an object or a person beneath the same. These cameras 4 can be used multi-functionally and can therefore also be used to detect leaks.

FIG. 2 is a schematic view of a roadway 5 with a region of interest 6 captured by one of the cameras 4. The camera 4 is coupled to a processing unit 7.

The cameras 4 can be operated as follows:

When the vehicle 1 is moving, the cameras 4 are switched off.

When the vehicle 1 is stationary, the cameras 4 take an image 8.1 to 8.n at regular intervals.

FIG. 3 is a schematic view of an image 8.1 taken by the camera 4.

The processing unit 7 compares each subsequently recorded image 8.2 to 8.n with the previously recorded image 8.1 to 8.n-1 or several of the previously recorded images 8.1 to 8.n-1. Multiple images increase security and also allow tracking if something is moving. Various image processing methods can be used, for example from simple difference calculations to complex deep learning methods, to detect and classify changes between images 8.1 to 8.n.

FIG. 4 is a schematic view of a sequence of images 8.2 to 8.6. If a difference between the images appears in the sequence, then it is classified. The classification serves to distinguish between different hypotheses, for example leak spot hypotheses 10.1 or false positive detections including animal hypotheses 10.2 if animals are moving beneath the vehicle 1, in particular small animals such as birds or mice, shadow hypotheses 10.3 for shadows and precipitation hypotheses 10.4 in case of rainwater running beneath the vehicle 1.

If no difference is detected, the next image is waited for and a difference is searched for.

If a difference is detected, then classification and determination of at least one hypothesis takes place.

If a leak spot hypothesis 10.1 has been verified multiple times, then its location is determined. By determining the location of the detection of leak spot hypotheses 10.1, a first defect hypothesis can be created, for example if these are located in predetermined regions 9.1, 9.2, which are known to be located beneath certain units of the vehicle 1. In this way, for example, the defect hypotheses fuel, cargo, transmission oil, axle bearing oil, battery fluid, brake fluid, coolant, urea (AdBlue®, assigned to VDA Verband der Automobilindustrie e.V.), engine oil, power steering fluid, etc. can be differentiated.

If a defect hypothesis has been determined, then an alarm with this defect hypothesis can be issued or transmitted to another unit of the vehicle 1. If no defect hypothesis has been determined, then an alarm without a defect hypothesis can be issued or transmitted to another unit of the vehicle 1.

FIG. 5 is a schematic view of a roadway 5 with a region of interest 6 captured by multiple cameras 4. The cameras 4 are coupled to a processing unit 7.

FIG. 6 is a schematic view of a concatenated image 11 formed from images 8.1 to 8.n of the cameras 4 by concatenation or fusion.

The analysis is analogous to the observation of images 8.1 to 8.n from only one camera 4. The analysis of the concatenated image 11 allows the detection of spots, in particular in predetermined regions 9.1 to 9.3, which occur across the various image boundaries, as well as the recognition of false positive detections.

The use of one or more cameras 4, supported for example by a lighting unit, solves the above-mentioned detection or avoidance of false positive detections due to shadows. Furthermore, true color analysis can be used to improve classification.

It can further be provided to arrange the camera 4 and the lighting unit at a distance from each other so that their own shadow is created and thus an improved analysis is possible in order to detect raised structures.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A commercial vehicle comprising:
at least one camera configured to detect leaks, wherein the at least one camera is arranged and aligned to capture an image of a region of interest beneath the commercial vehicle,
wherein a processing unit is connected to the camera and is configured to read the image from the at least one camera at regular intervals when the commercial vehicle is stationary and to detect differences between the images and to classify them as a hypothesis, and when a leak spot hypothesis is verified, to determine its location in relation to a number of predetermined regions beneath the commercial vehicle in order to establish a defect hypothesis related to the cause of the leak.

2. The commercial vehicle according to claim 1,
wherein the processing unit is configured to distinguish at least one type of fluid leak selected from a group consisting of: fuel, cargo, transmission oil, axle bearing oil, battery fluid, brake fluid, coolant, urea, engine oil and power steering fluid.

3. The commercial vehicle according to claim 1,
wherein the processing unit is configured to issue an alarm upon verification of a leak spot hypothesis.

4. The commercial vehicle according to claim 1,
wherein at least one lighting unit is configured to generate a shadow in the region of interest is arranged on the commercial vehicle.

5. The commercial vehicle according to claim 4,
wherein the at least one lighting unit is arranged at a distance from the at least one camera (4).

6. The commercial vehicle according to claim 1, wherein the processing unit is configured to identity differences between images using image difference calculations.

7. The commercial vehicle according to claim 1, wherein the processing unit is configured to identify differences between images using a deep learning program.

8. The commercial vehicle according to claim 1, wherein the processing unit is configured to issue an alarm upon verification of the leak spot hypothesis.

9. The commercial vehicle according to claim 2,
wherein at least one lighting unit is configured to generate a shadow in proximity to the region of interest.

10. The commercial vehicle according to claim 1,
wherein at least one lighting unit is configured to generate a shadow in proximity to the region of interest.

11. A method for operating a commercial vehicle, the commercial vehicle including at least one camera in communication with a processing unit configured to identify a leak, the method comprising:
capturing, via the at least one camera, a series of images of a region of interest proximate to the commercial vehicle;
comparing, via the processing unit, each respective image with other images in the series; and
determining, via the processing unit, whether the leak is present based on differences between images in the series, wherein the processing unit is configured to identify a location of the leak.

12. The method of claim 11, the method further comprising identifying, via the processing unit, a fluid type of the leak.

13. The method of claim 12, wherein the fluid type associated with the fluid type of leak is selected from a group consisting of: fuel, cargo, transmission oil, axle bearing oil, battery fluid, brake fluid, coolant, urea, engine oil and power steering fluid.

14. The method of claim 11, the method further comprising transmitting an alarm based on the detection of the fluid type of leak.

15. The method of claim 11, wherein the commercial vehicle further comprises at least one lighting unit positioned a distance from the at least one camera.

16. The method of claim 15, the method further comprising projecting, via the at least one lighting unit, a light across the region of interest; and identifying, via the processor, raised structures of the region of interest.

17. The method of claim 11, wherein the processing unit is configured to execute a deep learning program to compare images.

18. The method of claim 11, wherein the processing unit is configured to execute image difference calculations to compare images.

19. The method of claim 11, wherein the vehicle further comprises a plurality of cameras.

20. The method of claim 19, the method further comprising, fusing, via the processing unit, a plurality of images captured by the plurality of cameras at a synchronized point in time, prior to analyzing the series of images to detect the leak.
